(19) United States
(12) Patent Application Publication
(10) Pub. No.: US 2013/0247358 A1
(43) Pub. Date: Sep. 26, 2013

(54) LOTTO SCRATCH PAD AND METHOD OF COLLECTING SHAVINGS

(71) Applicant: Shane Watson, Cumming, GA (US)

(72) Inventor: Shane Watson, Cumming, GA (US)

(21) Appl. No.: 13/428,453

(22) Filed: Mar. 23, 2012

(51) Int. Cl. B23Q 3/00

(52) U.S. Cl. 29/559; 269/289 R

(57) ABSTRACT

A lotto scratch pad and method of collecting scrapings, in general, a holding device having a backer board or hard surface with a clasp or clip attached thereto and positioned approximate one edge of the backer board, at least one collection bin, compartment, trough or receptacle positioned on another edge of the backer board having a hinged tab to enclose lotto ticket shavings therein and, thus, functions to collect and contain any scrapings created as a player scratches the opaque covering off scratch tickets on the holding device.

### TECHNICAL FIELD

The disclosure generally relates to a holding device with a clasp, and more specifically an apparatus to secure a lottery ticket for use in scrapping coatings from lottery tickets.

### BACKGROUND

Lottery scratch tickets, which are also referred to as scratch cards and scratch offs, are a popular form of gambling and are sold at establishments such as convenience stores, liquor stores, filling stations, as well as other retail outlets. Lottery scratch tickets are usually made of paper or cardboard having one or more areas covered by an opaque covering, which is usually latex that can be scratched off. These tickets require a player to match one or more numbers, symbols, pictures and/or words printed on the scratch ticket to win a prize amount.

When a player buys a lottery scratch ticket, the player normally pulls out a coin, a key, or other edged object and places the back of the ticket against a hard surface. The player then scratches off the opaque covering to reveal variable information such as numbers and prize amounts printed on the lottery scratch ticket. When the player performs this task, it is common for the opaque covering to accumulate on the clothes of the consumer or other undesirable places such as the floor, such as carpet or on the seats of an automobile or other location. The resulting residue is not only unsightly, but is difficult to remove from fabric and upholstery as well.

An additional problem is that a solid surface is always needed in order for a player to be able to apply enough pressure to a lottery scratch ticket to scratch off the opaque covering. An even further problem is that lottery players often misplace and/or loose lottery tickets because they do not have a place to hold and store the tickets.

Therefore, it is readily apparent that there is a recognizable unmet need for a lotto scratch pad and method of collecting scrapings that functions to hold and store scratch tickets and other lottery tickets, provide a hard surface to scratch a scratch ticket against and provide a means for collecting and containing the scrapings created by scratching the opaque covering off of the scratch ticket without creating a mess in the process.

### SUMMARY

Briefly described, in an example embodiment, the present apparatus and method overcomes the above-mentioned disadvantages and meets the recognized need for a lotto scratch pad and method of collecting scrapings comprising, in general, a holding device having a backer board or hard surface with a clasp or clip attached thereto and positioned approximate one edge of the backer board, at least one collection bin, compartment, trough or receptacle positioned on another edge of the backer board having a hinged tab to enclose lotto ticket shavings therein and, thus, functions to collect and contain any scrapings created as a player scratches the opaque covering off scratch tickets on the holding device.

In use, the lotto scratch pad may be utilized to 1) secure a scratch ticket to the holding device and 2) collect and contain any scrapings created as a player scratches the opaque covering off scratch tickets on the holding device.

According to its major aspects and broadly stated, the present article meets the recognized need for a holding device for supporting a scratch ticket while scratching off a coating of scrapings therefrom, comprising a base having a surface to support the scratch ticket, a clasp affixed to the base and approximate a first edge of the base, at least one receptacle positioned approximate a second edge of the base configured to collect the scratch ticket scrapings, and at least one cover positioned approximate the receptacle configured to contain the scratch ticket scrapings within the at least one receptacle.

In a further exemplary embodiment, A holding device for supporting a scratch ticket while scratching off a coating of scrapings therefrom, comprising a base having a surface to support the scratch ticket, a clasp affixed to the base and approximate a first edge of the base, at least one receptacle positioned approximate a second edge of the base configured to collect the scratch ticket scrapings, at least one cover positioned approximate the receptacle configured to contain the scratch ticket scrapings within the at least one receptacle, and at least one hinge positioned between the receptacle and the cover.

In a further exemplary embodiment of a method of collecting scrapings from a coating scratched from a scratch ticket comprising the steps of providing a holding device comprising a base having a surface to support the scratch ticket, a clasp affixed to the base and approximate a first edge of the base, at least one receptacle positioned approximate a second edge of the base configured to collect the scratch ticket scrapings, and at least one cover positioned approximate the receptacle configured to contain the scratch ticket scrapings within the at least one receptacle, positioning the first scratch ticket on the base, securing the scratch ticket under the clasp to the base, scratching the coating off the scratch ticket, and collecting scrapings in the receptacle.

Accordingly, a feature of the lotto scratch pad and method of collecting scrapings is its ability to provide a means for collecting the scrapings created by scratching the opaque covering off of the scratch ticket.

Another feature of the lotto scratch pad and method of collecting scrapings is its ability to provide a hard surface for playing and scraping.

Yet another feature of the lotto scratch pad and method of collecting scrapings is its ability to provide a lottery scratch ticket holding device that is light weight, compact and easy to store in an automobile, in a glove box, center console, sun visor and so forth.

Yet another feature of the lotto scratch pad and method of collecting scrapings is its ability to provide a holding device having a board with a clip or clasp attached thereto.

Yet another feature of the lotto scratch pad and method of collecting scrapings is its ability to provide a design that accommodates left and right hand players.

Yet another feature of the lotto scratch pad and method of collecting scrapings is its ability to provide a player with a means to attach a scratch ticket to the board using the clip or clasp.

Yet another feature of the lotto scratch pad and method of collecting scrapings is its ability to accommodate a variety of scratch tickets, such as size, shape, and function.

Yet another feature of the lotto scratch pad and method of collecting scrapings is its ability to provide a stylish pad to personalize the appearance for aesthetic, display, marketing and sales purposes.

Yet another feature of the lotto scratch pad and method of collecting scrapings is its ability to provide a low cost device which will hold and store scratch tickets and other lottery tickets.

Yet another feature of the lotto scratch pad and method of collecting scrapings is its ability to provide a board or scratch pad formed of a disposable material, such as recycled material.

Yet another feature of the lotto scratch pad and method of collecting scrapings is its ability to provide a solid surface for a user to scratch a scratch ticket against.

Yet another feature of the lotto scratch pad and method of collecting scrapings is its ability to provide a clip or clasp to hold and store multiple scratch tickets and other lottery tickets on the board one stacked on top of the other.

Yet another feature of the lotto scratch pad and method of collecting scrapings is its ability to provide a clip or clasp to hold and store one or more scratch tickets in place while scratching.

Yet another feature of the lotto scratch pad and method of collecting scrapings is its ability to provide a receptacle, located on the bottom portion of the holding device, to collect any scrapings created as a user scratches the opaque covering off scratch tickets on the holding device.

Yet another feature of the lotto scratch pad and method of collecting scrapings is its ability to provide a receptacle, located on the side portion of the holding device, to collect any scrapings created as a user scratches the opaque covering off scratch tickets on the holding device.

Yet another feature of the lotto scratch pad and method of collecting scrapings is its ability to provide a closeable tab for the receptacle to trap any scrapings created as a user scratches the opaque covering off scratch tickets on the holding device.

Yet another feature of the lotto scratch pad and method of collecting scrapings is its ability to provide a side and bottom receptacles that is in close proximity to the scratch ticket so that any scrapings from a scratch ticket may be pushed, brushed or otherwise directed into the receptacle.

Yet another feature of the lotto scratch pad and method of collecting scrapings is its ability to provide a predetermined amount of usage, the receptacle may be emptied into an appropriate trash container so that scrapings are not displaced into the lap or other unwanted location.

Yet another feature of the lotto scratch pad and method of collecting scrapings is its ability to provide a storage means for scratch ticket scrapings until they can be properly and conveniently disposed of.

These and other features of the lotto scratch pad and method of collecting scrapings will become more apparent to one skilled in the art from the following Brief Description of the Drawings, Detailed Drawings, Detailed Description and Claims when read in light of the accompanying drawings.

### BRIEF DESCRIPTION OF THE DRAWINGS

The present lotto scratch pad and method of collecting scrapings or the like will be better understood by reading the Detailed Description of the embodiments with reference to the accompanying drawings, in which like reference to numerals denote similar structures and refer to like elements throughout, and in which:

FIG. 1 is a top view of an example embodiment of the lotto scratch pad;

FIG. 2 is a top perspective view of an example embodiment lotto scratch pad shown in FIG. 1;

FIG. 3 is a bottom side view of alternate example embodiment of the lotto scratch pad shown in FIG. 1;

FIG. 4 is a side view of an example embodiment lotto scratch pad integrated in or placed on a kiosk; and

FIG. 5 is a flow diagram of a method of collecting scrapings.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

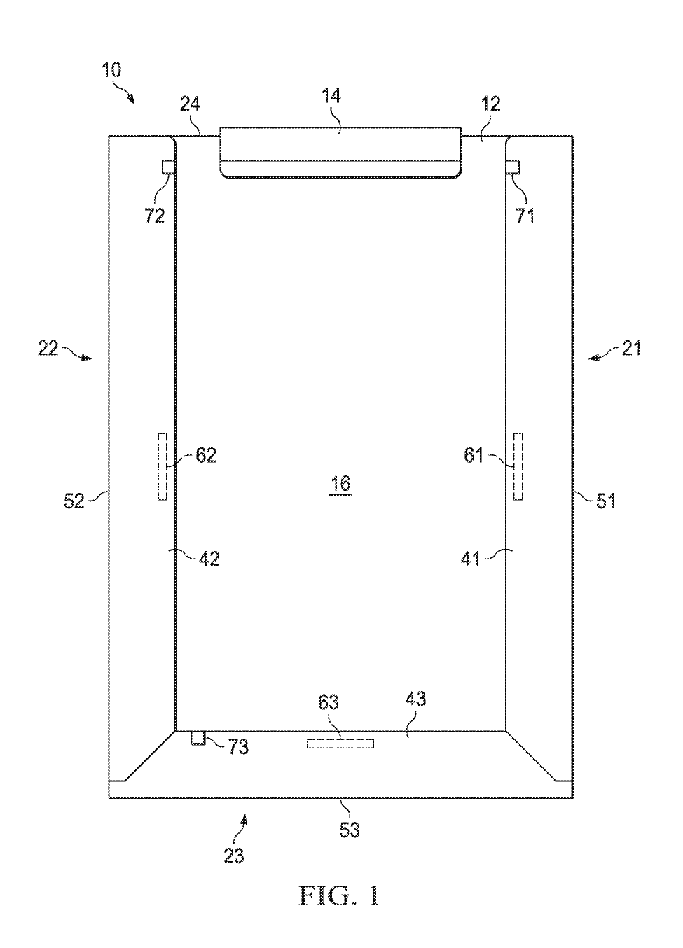

In describing the exemplary embodiments of the present disclosure, as illustrated in FIGS. 1-5 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

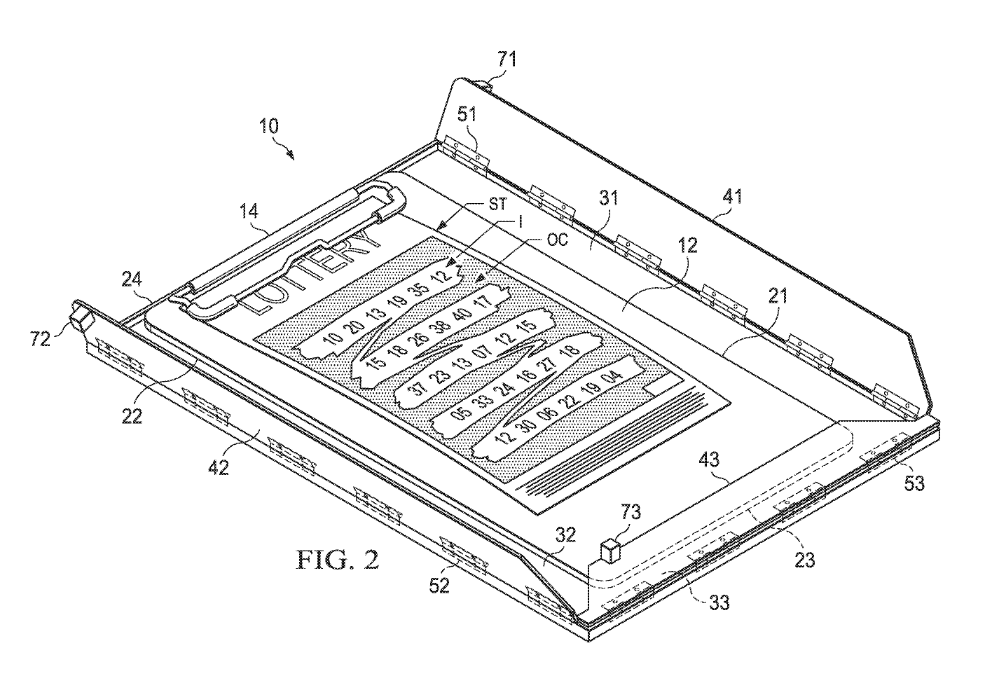

Referring now to FIG. 1 by way of example, and not limitation, there is illustrated an example embodiment of the scratch pad, lottery accessory, scratch ticket holding device, scratch ticket tray, or holding device, such as scratch pad 10. Preferably, scratch pad 10 includes a surface, backer board, hard surface, or planar surface, such as base 12, to provide a hard surface to support and scratch a scratch ticket against, having one or more sides or edges around the periphery, such as edge 21, 22, 23, and 24, arranged preferably as, a rectangle-like structure and one or more surfaces 16. It is contemplated herein that configurations other than rectangle-like are contemplated herein including other shapes and sizes of scratch pad 10 known to one of ordinary skill in the art. Moreover, scratch pad 10 preferably includes one or more storage bin, tray, compartment, partition, channel, trench, depression or trough, such as receptacle 31, 32 and 33, positioned approximate or adjacent edges 21, 22, 23, respectively to collect, gather, or accumulate scratch ticket scrapings. Further, scratch pad 10 preferably includes one or more cap, lid, or flap, such as cover 41, 42 and 43, positioned approximate receptacle 31, 32 and 33, respectively, and shown as a top, seal or cover receptacle 31, 32 and 33 to contain, hold, enclose, conceal, envelope or restrain scratch ticket scrapings. Still further, scratch pad 10 preferably includes one or more joint, elastic, flexible, pliable, bias element or bendable transitions or mechanisms such as hinge 51, 52 and 53 positioned between receptacle 31, 32 and 33 and cover 41, 42 and 43, respectively. Preferably, hinged 51, 52 and 53 enables cover 41, 42 and 43 to move from a closed position (shown) to an open position, shown in FIG. 2.

It is contemplated herein that cover 41, 42 and 43 may be releasably affixed or detachable from receptacle 31, 32 and 33, and thus re-affixed by, such as friction fit therebetween receptacle 31, 32 and 33 and cover 41, 42 and 43, respectively.

Moreover, scratch pad 10 preferably includes one or more magnetic strips, hook and loop, snap or latch such as attachment mechanism 61, 62 and 63 positioned approximate cover 41, 42, 43 and/or base 12 and/or receptacle 31, 32 and 33 and configured to affix or maintain cover 41, 42 and 43 in a closed position (shown) relative to receptacle 31, 32 and 33 and enclose or contain the contents therein receptacle 31, 32 and 33. Furthermore, cover 41, 42 and 43 preferably include one or more handle, knob, lever or protrusion, such as tab 71, 72 and 73 positioned approximate or on cover 41, 42, 43, respectively, to enable cover 41, 42 and 43 to be moved from a closed position (shown) to an open position, shown in FIG. 2.

Scratch pad 10 is preferably formed, molded or configured from a suitable material, such as plastic, polymer or alternative resin, cardboard, rubber, fiber, foam filled material, synthetic, rubber, wood, metal, aluminum, alloy, steel, or shape memory metal or any rigid or semi-rigid composite material or the like and any manufacturing method, capable of providing structure to scratch pad 10 known to one of ordinary skill in the art. Preferably, the material includes other suitable characteristics, such as light weight, strength, rigid surface, durability, water-resistance, wearability, chemical inertness, smooth, slick, nonstick, oxidation resistance, ease of workability, longevity, or other beneficial characteristic understood by one skilled in the art.

Base 12, receptacle 31, 32 and 33 and/or cover 41, 42 and 43 and/or surface 16 may include a rich-textured or luxurious fabric sheet or surface layer such as cotton, linen, velvet, flock, faux leather (Vienna™), faux suede, silk, burlap, indicia, trademark or the like, or a low friction material, such as a soft rubber or polymer, or the like covering or exterior surface of scratch pad 10 or marked with an indicia or trademark to provide a high end appearance for marketing and sales display of scratch pad 10. Moreover, edges 21, 22, 23, and 24 may be configured to be curved or contoured.

It is contemplated herein that scratch pad 10 may be integrated into a folder or book cover format as a high end scratch pad 10.

It is recognized herein that the width to length dimensions of edges 23 and 24 are approximately 6 and 15/16 inches wide and edges 21 and 22 are approximately 9 and 5/16 inches long; however, other sizes and shapes for scratch pad 10 are contemplated herein.

It is further recognized that scratch pad 10 may be configured to accommodate a variety scratch tickets, such as size, shape, and function.

Referring now to FIG. 2 by way of example, and not limitation, there is illustrated an example embodiment of scratch pad 10. Preferably, base 12 of scratch pad 10 further includes an optional clip or bias device, such as clasp 14 affixed thereto and approximate one edge, such as edge 24 of base 12. In use, clasp 14 is preferably utilized to releasably affix, secure or hold at least one lottery scratch ticket, scratch cards or scratch offs, such as scratch ticket ST on the planar surface 16 of base 12. A player or user secures scratch ticket ST to base 12 by inserting one end of scratch ticket ST there under clasp 14 and preferably uses a coin, a key, or other edged object, such as scraping device SD to scrape or scratch off the opaque coating or covering OC (producing residue or shavings such as scrapings) from the scratch ticket ST to reveal variable information I such as numbers, symbols and prize amounts printed on the scratch ticket ST. Moreover, open position covers 41, 42 (shown in FIG. 2) or 43 reveal respective receptacle 31, 32 or 33, which function to collect any scrapings or shavings as a player scratches opaque covering OC off of scratch ticket ST while securely positioned on scratch pad 10 under clasp 14.

It is contemplated herein that clasp 14 may be utilized to display or hang scratch pad 10 from a merchandising hook as is a common way of displaying articles for sale.

It is further contemplated herein that clasp 14 affixed thereto base 12 may be utilized to store multiple scratch tickets and other lottery tickets on the board.

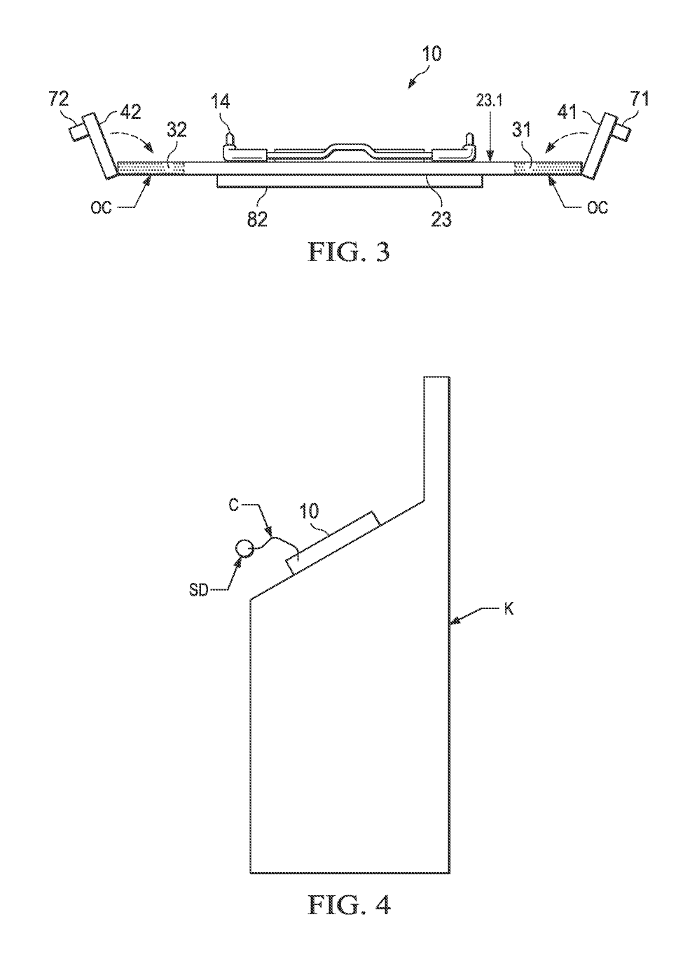

Referring now to FIG. 3 by way of example, and not limitation, there is illustrated an example embodiment of scratch pad 10. In use, open position cover 41 or 42 of respective receptacle 31 or 32 function to collect any trimmings, scrapings or shavings of opaque covering OC created as a player scratches the opaque covering OC off scratch ticket ST when securely positioned on scratch pad 10. A player may scratch one or more scratch tickets ST one after the other and push, brush or otherwise direct the scrapings or shavings of opaque covering OC into respective receptacle 31, 32 or 33. Preferably, at the conclusion of the scrapping session a player or user of scratch pad 10 may move cover 41, 42 or 43 to its closed position (shown in FIG. 1) to cover or enclose respective receptacle 31, 32 or 33, and thus, function to collect, contain and compartmentalize any scrapings or shavings of opaque covering OC within receptacle 31, 32 or 33. Moreover, closed cover 41, 42 or 43 (shown in FIG. 1) of respective receptacle 31, 32 or 33 functions to hold, store, scratch tickets and other lottery tickets, and provide a hard surface to support and scratch a scratch ticket against and to provide a way to trap or collect or contain the scrapings or shavings created by scratching the opaque covering OC off the scratch ticket ST without having the scrapings or shavings of opaque covering OC on the clothes of the player or user and prevent their accumulation in other undesirable places such as the floor, such as carpet, or on the seats of an automobile or other location. Further, after a predetermined amount of usage of scrapping scratch ticket ST receptacle 31, 32 or 33 may be emptied of their residue into a trash container so that the scrapings or shavings of opaque covering OC are not displaced into the lap or other unwanted location.

Furthermore, a player may utilize storage slot 82 preferably located on the underside of scratch pad 10 to hold or store one or more scratch tickets ST or the like for safe keeping before or after scratching.

It is contemplated herein that scratch pad 10 having receptacle 31 or 32 on left and right sides of positioned scratch tickets ST accommodates left and right hand players.

It is contemplated herein that scratch pad 10 may be utilized to provide a storage means for scratch ticket ST scrapings until they can be properly and conveniently disposed of.

It is contemplated herein that in an alternate exemplary embodiment that edge 23 may be raised edge 23.1 so as to block any shavings from falling off the bottom end of scratch pad 10.

Referring now to FIG. 4 by way of example, and not limitation, there is illustrated an example embodiment of scratch pad 10. Preferably scratch pad 10 may be integrated or positioned on a surface of kiosk K or other table or platform to assist a player or user with scrapping or scratching scratch tickets ST with scratch pad 10.

It is contemplated herein that scratch pad 10 may include scraping device SD, used to scrape the opaque covering OC from scratch tickets ST. Scraping device SD may be permanently attached to scratch pad 10 or kiosk K via a chain C, string or similar device.

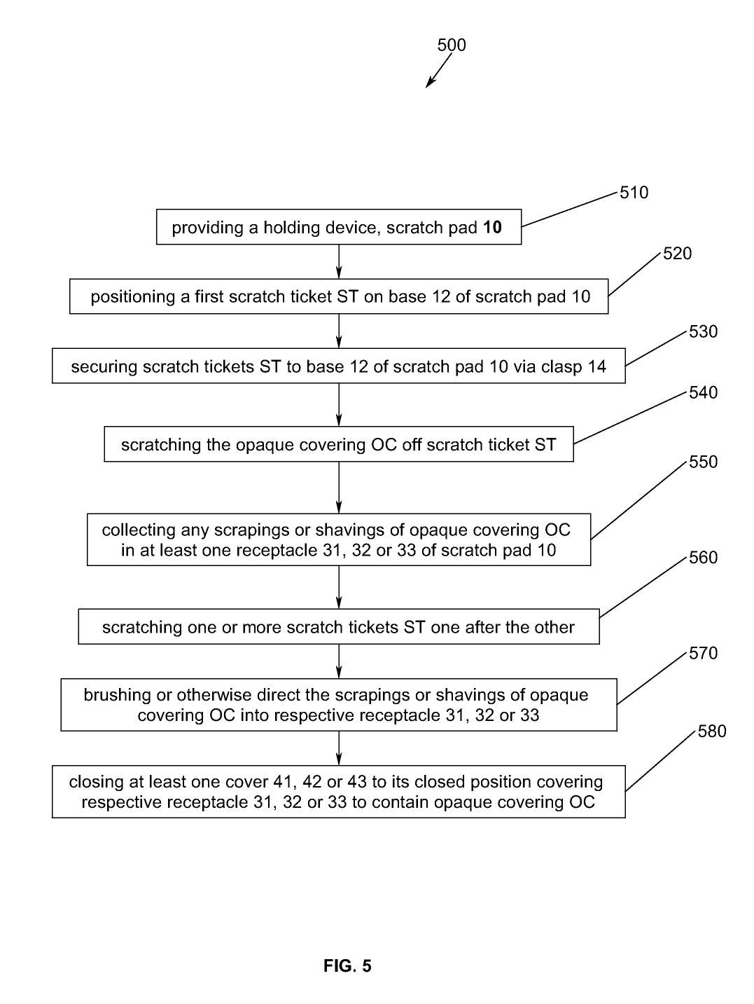

Referring now to FIG. 5, there is illustrated flow diagram 500 for a method of collecting and holding scrapings of opaque covering OC from scratch tickets ST. In block or step 510, providing a holding device, scratch pad 10, having a backer board or hard surface with a clasp or clip attached thereto and positioned approximate one edge of the backer board, at least one collection bin, compartment, trough or receptacle positioned on another edge of the backer board having a hinged tab to enclose lotto ticket shavings therein and, thus, functions to collect and contain any scrapings created as a player scratches the opaque covering off scratch tickets on the holding device, as described above in FIGS. 1-4. In block or step 520, positioning a first scratch ticket ST on base 12 of scratch pad 10. In block or step 530, securing scratch tickets ST to base 12 of scratch pad 10 via clasp 14. In block or step 540, scratching the opaque covering OC off scratch ticket ST. In block or step 550, collecting any scrapings or shavings of opaque covering OC in at least one receptacle 31, 32 or 33 of scratch pad 10. In block or step 560, scratching one or more scratch tickets ST one after the other. In block or step 570, brushing or otherwise directing the scrapings or shavings of opaque covering OC into respective receptacle 31, 32 or 33. In block or step 580, closing at least one cover 41, 42 or 43 to its closed position to seal respective receptacle 31, 32 or 33 to contain opaque covering OC.

The foregoing description and drawings comprise illustrative embodiments of the present invention. Having thus described exemplary embodiments, it should be noted by those ordinarily skilled in the art that the disclosures within are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains, having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

Therefore, at least the following is claimed:

1. A holding device for supporting a scratch ticket while scratching off a coating of scrapings therefrom, comprising:
a base having a surface to support the scratch ticket;
a clasp affixed to said base and approximate a first edge of said base;
at least one receptacle positioned approximate a second edge of said base configured to collect the scratch ticket scrapings; and
at least one cover positioned approximate said receptacle configured to contain the scratch ticket scrapings within said at least one receptacle.

2. The device according to claim 1, wherein the scratch ticket is secured to said base by said clasp.

3. The device according to claim 1, wherein said receptacle is adjacent to at least two edges of said base.

4. The device according to claim 1, wherein said receptacle is adjacent to at least three edges of said base.

5. The device according to claim 1, further comprises at least one hinge positioned between said receptacle and said cover.

6. The device according to claim 5, wherein said hinge is configured to enable said cover to move between an open position and a closed position.

7. The device according to claim 1, wherein said clasp is configured to hang the device.

8. The device according to claim 1, further comprises at least one tab positioned on said cover.

9. The device according to claim 8, wherein said tab is configured to assist movement of said cover between an open position and a closed position.

10. The device according to claim 1, further comprises an attachment mechanism positioned between said receptacle and said cover.

11. The device according to claim 10, wherein said attachment mechanism is configured to maintain said cover in a closed position.

12. The device according to claim 1, wherein said surface further comprises a textured surface.

13. The device according to claim 1, wherein said surface further comprises a low friction material.

14. A holding device for supporting a scratch ticket while scratching off a coating of scrapings therefrom, comprising:
a base having a surface to support the scratch ticket;
a clasp affixed to said base and approximate a first edge of said base;
at least one receptacle positioned approximate a second edge of said base configured to collect the scratch ticket scrapings;
at least one cover positioned approximate said receptacle configured to contain the scratch ticket scrapings within said at least one receptacle; and
at least one hinge positioned between said receptacle and said cover.

15. The device according to claim 14, wherein the scratch ticket is secured to said base by said clasp.

16. The device according to claim 14, wherein said receptacle is adjacent to at least two edges of said base.

17. The device according to claim 14, wherein said receptacle is adjacent to at least three edges of said base.

18. The device according to claim 14, wherein said hinge is configured to enable said cover to move between an open position and a closed position.

19. The device according to claim 14, wherein said clasp is configured to hang the device.

20. The device according to claim 14, further comprises at least one tab positioned on said cover.

21. The device according to claim 20, wherein said tab is configured to assist movement of said cover between an open position and a closed position.

22. The device according to claim 14, further comprises an attachment mechanism positioned between said receptacle and said cover.

23. The device according to claim 22, wherein said attachment mechanism is configured to maintain said cover in a closed position.

24. The device according to claim 14, wherein said surface further comprises a textured surface.

25. The device according to claim 14, wherein said surface further comprises a low friction material.

26. A method of collecting scrapings from a coating scratched from a scratch ticket comprising the steps of:
providing a holding device comprising a base having a surface to support the scratch ticket, a clasp affixed to said base and approximate a first edge of said base, at least one receptacle positioned approximate a second edge of said base configured to collect the scratch ticket scrapings, and at least one cover positioned approximate said receptacle configured to contain the scratch ticket scrapings within said at least one receptacle;
positioning the first scratch ticket on said base;
securing the scratch ticket under said clasp to said base;
scratching the coating off the scratch ticket; and
collecting scrapings in said receptacle.

27. The method of claim 26, further comprising the step of directing the scrapings into said receptacle.

28. The method of claim 26, further comprising the step of closing said cover to seal the scrapings in said receptacle.
